(19) United States
(12) Patent Application Publication
(10) Pub. No.: US 2007/0039778 A1
(43) Pub. Date: Feb. 22, 2007

(54) Escape system for a building

(76) Inventor: James L. Ashmus, Kenosha, WI (US)

Correspondence Address: JANSSON, SHUPE, MUNGER & ANTARAMIAN, LTD, 245 MAIN STREET, RACINE, WI, 53403, US

(21) Appl. No.: 11/207,445

(22) Filed: Aug. 19, 2005

(51) Int. Cl. A62B 1/06

(52) U.S. Cl. 182/73

(57) ABSTRACT

An escape system for a building including an endless belting ladder formed by an endless elongated band of a flat flexible reinforced belting material having a plurality of longitudinally-spaced apertures each with a substantially transverse edge portion thereby forming rung-like features along the belting material to receive a person's foot or hand; and a pulley system characterized by a support structure mountable to the building, at least one substantially cylindrical member rotatably secured with respect to the support structure, and a speed reducer controlling the rotation of the cylindrical member. The endless band is secured around the cylindrical member.

### FIELD OF THE INVENTION

The present invention relates to flexible ladders for emergency escape from buildings.

### BACKGROUND OF THE INVENTION

A variety of flexible ladders and the like have long existed for use in various emergency situations, a prime example of which is use for escape from burning buildings. Among other things, the prior art includes a variety of rope ladders, ladders with rigid rungs connected by ropes or chains, flat bands intended for use in descending, and other structures which can be collapsible for storage purposes.

Many of the prior art devices have significant disadvantages and shortcomings and there is a need for innovation in the field. For some devices, collapsing for compact storage is problematic or has disadvantages. There may be difficulty in unfurling the structure for use in a time of emergency, with susceptibility to problems such as tangling. Certain prior disclosures of flat band devices have problematic slit-like features which can tend to pose difficulties for persons trying to lower themselves—problems related to difficulty in securing proper foot engagement with the device. Excessive flexibility is another problem, as is limited capability for dealing concurrently with multiple persons seeking to escape, e.g., from a burning building. Furthermore, it is noted that potential revisions of prior structures for the purpose of alleviating certain problems Can introduce or exacerbate other problems.

An important issue for any escape ladder is its immediate availability in fully operative condition in case of emergencies, which may happen decades after installation. Such availability can be achieved by storing escape ladders immediately next to windows or on the roof of a building in such a way that, when needed, the ladder can be dropped down for evacuation. Certain collapsible ladders may tend not to withstand long-term outdoor storage because of being susceptible to rot, rust and other types of destruction. Prior art ladders may need to be covered by protective structure outside.

In summary, there is a need for an improved collapsible ladder that overcomes some of the problems and shortcomings of the prior art, and provides highly reliable fire-escape apparatus.

### OBJECTS OF THE INVENTION

It is an object of the invention to provide an improved escape system for a building overcoming some of the problems and shortcomings of the prior art, including those referred to above.

Another object of the invention is to provide an escape system incorporating an endless ladder-like device which is sufficiently flexible to facilitate compact storage while being sufficiently fixed in its form to facilitate unfurling and stability of position during usage in an emergency.

Another object of the invention is to provide an escape system incorporating an endless ladder-like device having the advantages mentioned herein and at the same time allowing relatively effortless positioning by a person of his or her feet and hands thereon for secure descend.

Still another object of the invention is to provide an escape system incorporating an endless ladder-like device which can be readily stored outside for an extended period of time.

How these and other objects are accomplished will become apparent from the following descriptions and the drawings.

### SUMMARY OF THE INVENTION

The present invention provides an improved escape system for a building for secure relatively effortless descend of a person.

The inventive escape system includes an endless belting ladder formed by an endless elongated band of a flat flexible reinforced belting material having a plurality of longitudinally-spaced apertures each with a substantially transverse edge portion thereby forming rung-like features along the belting material to receive a person's foot or hand; and a pulley system having a support structure mountable to the building, at least one substantially cylindrical member rotatably secured with respect to the support structure, and a speed reducer controlling the rotation of the cylindrical member. The endless band is secured around the cylindrical member.

In the most highly preferred embodiments of this invention, the speed reducer is a gear box set for a maximum speed controlling the descending movement of the belting ladder. The gear may be pre-arranged to predetermine the highest speed for rotation of the cylindrical member so the endless belting ladder is adapted to travel without exceeding a given maximum speed irrespective of the number of people descending at the same time.

The inventive escape system does not require electric or battery power for functioning. The belting ladder will begin to descend due to the weight of a person providing continues automatic movement. Because of the relatively steady structure of the belting material complemented by the design of the apertures forming rung-like features, the inventive escape system provides relatively effortless evacuation for people of average or low strength and without any special skills. A person can just grab on the closest part of the belting ladder, place his or her foot into the aperture which can be easily located, and remain in such position until reaching the height comfortable jumping or stepping down on the ground or safe platform.

In some alternative embodiments of the escape system the pulley system may further include at least one braking cord for slowing or stopping the descend of the endless belting ladder by pulling the cord.

In highly preferred embodiments of this invention, the support structure includes a frame having a central bar, an overhead shaft, and a first and a second lower rods. In such embodiments the one cylindrical member is a head pulley rotatably secured with respect to the central bar. The pulley system also preferably includes an adjustable spring-tension-roller mounted on the overhead shaft. Furthermore, a first and a second adjustable belt-snubbers are respectively positioned on the first and the second lower rods.

In certain highly preferred embodiments the escape system includes a set of safety belts with hooks for securing persons to the ladder. The safety belts are stored within a fireproof box affixed to the support structure.

In special highly preferred embodiments of the invention the belting ladder forms a coil for storing. The escape system further includes a tug-tab for releasing the belting ladder from a coiled orientation into an extended suspended orientation. In some cases, the fire-escape belting ladder may further include an alarm-actuated device for releasing the belting ladder.

In the inventive belting ladder, the preferred belting material of the elongated band is conveyer belting—i.e., material of the type used for conveyor belts. The term “conveyer belting” as used herein refers to tough flat polymeric materials such as rubber, nylon, PVC or other strong yet flexible material which is flexible in the sense and to the extent that it can be rolled up into a coil but still retains sufficient form when a user's weight is applied at an aperture therein. Such conveyor belting typically includes flexible elongate reinforcement elements therein which extend through, are surrounded by, and adhere to the flat polymeric belting material. The elongate reinforcement may be made of metal, polymer, fiber, vegetable textile threads or other suitable materials used for manufacturing conveyer belting.

There is a wide variety of conveyor belting material which is suitable for the present invention and the above definition is in no way limiting for a special type of belting material. Moreover, new, used or scrap conveyer belting can also be used for the present invention.

In certain preferred embodiments the apertures have substantially round shapes with preferred diameter of approximately six inches.

In some preferred embodiments the transverse edge portions are substantially straight horizontal edges with the belting ladder being vertically oriented. In some of such embodiments, the apertures have substantially rectangular shapes preferably having width and height of approximately six inches.

### BRIEF DESCRIPTION OF THE DRAWINGS

FIG. 1 is an isometric view of an escape system for a building showing the endless belting ladder in suspended orientation.

FIG. 2 is an isometric view of the escape system for a building showing the endless belting ladder in coiled orientation.

FIG. 3 is a side elevation of a portion of the escape system immediately around the head pulley.

FIG. 4 is an isometric view of the belting ladder in coiled orientation showing the speed reducer.

FIG. 5 is a front view of a portion of the escape system immediately around the head pulley.

FIG. 6 is a front elevation of the belting ladder having an alternative arrangement of the apertures.

FIG. 7 is a front elevation of the belting ladder showing apertures having substantially rectangular shapes.

### DETAILED DESCRIPTION OF PREFERRED EMBODIMENTS

FIGS. 1-7 illustrate an inventive escape system 10 for a building 1. Referring to the figures, inventive escape system 10 includes an endless belting ladder 20 formed by an endless elongated band 22 with a width 24 of a flat flexible reinforced belting material 26 having a plurality of longitudinally-spaced apertures 30 each with a substantially transverse edge portion 32 thereby forming rung-like features 34 along belting material 26 to receive a person's foot or hand; and a pulley system 40 having a support structure 42 mountable to building 1, at least one substantially cylindrical member 44 rotatably secured with respect to support structure 42, and a speed reducer 46 controlling the rotation of cylindrical member 44. Endless band 22 is secured around cylindrical member 44.

As seen on FIG. 4 speed reducer 46 is a gear box 47 set for a maximum speed controlling descending movement of belting ladder 20.

FIG. 5 shows an optional braking cord 48 for slowing or stopping the descend of endless belting ladder 20 by pulling cord 48.

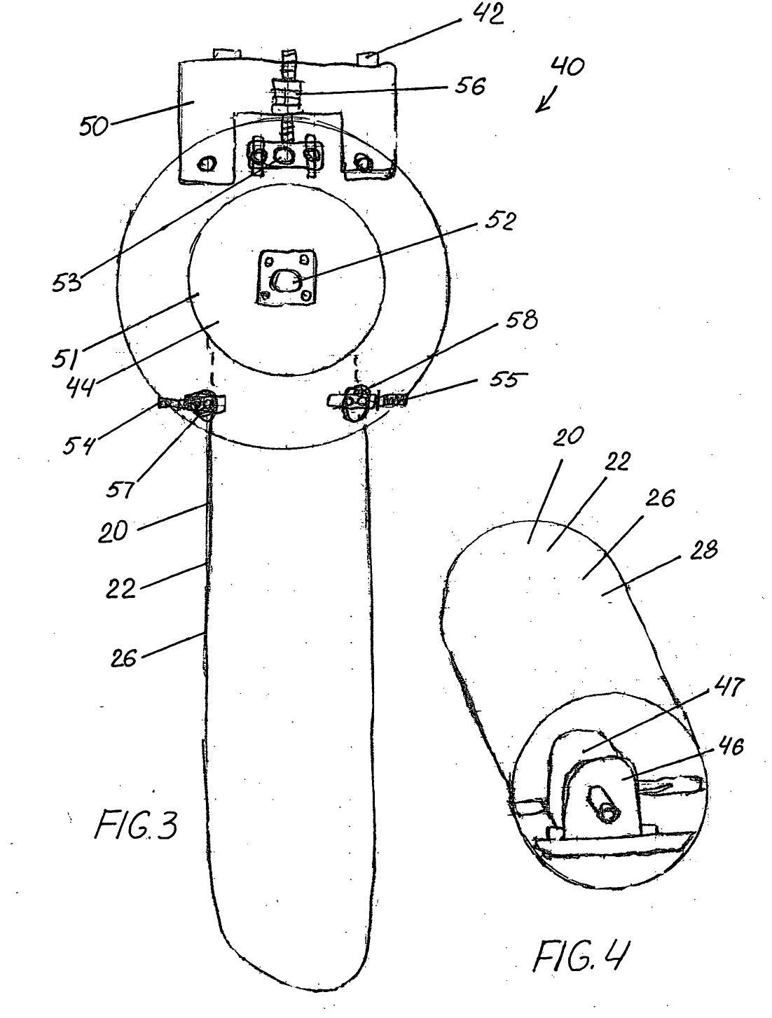

FIGS. 3 and 5 best illustrate support structure 42 including a frame 50 having a central bar 52, an overhead shaft 53, and a first and a second lower rods 54 and 55, respectively. Cylindrical member 44 is a head pulley 51 rotatably secured with respect to central bar 52. As best seen on FIG. 3 pulley system 40 also includes an adjustable spring-tension-roller 56 mounted on overhead shaft 53. Furthermore, a first adjustable belt-snubber 57 and a second adjustable belt-snubber 58 are respectively positioned on first and second lower rods 54 and 55.

FIG. 1 further shows a fireproof box 60 affixed to the support structure 42 A set of safety belts 60 with hooks for securing persons to ladder 20 are stored within fireproof box 62. For illustrative purposes only, box 62 is shown with cut-away wall to open view to belts 60.

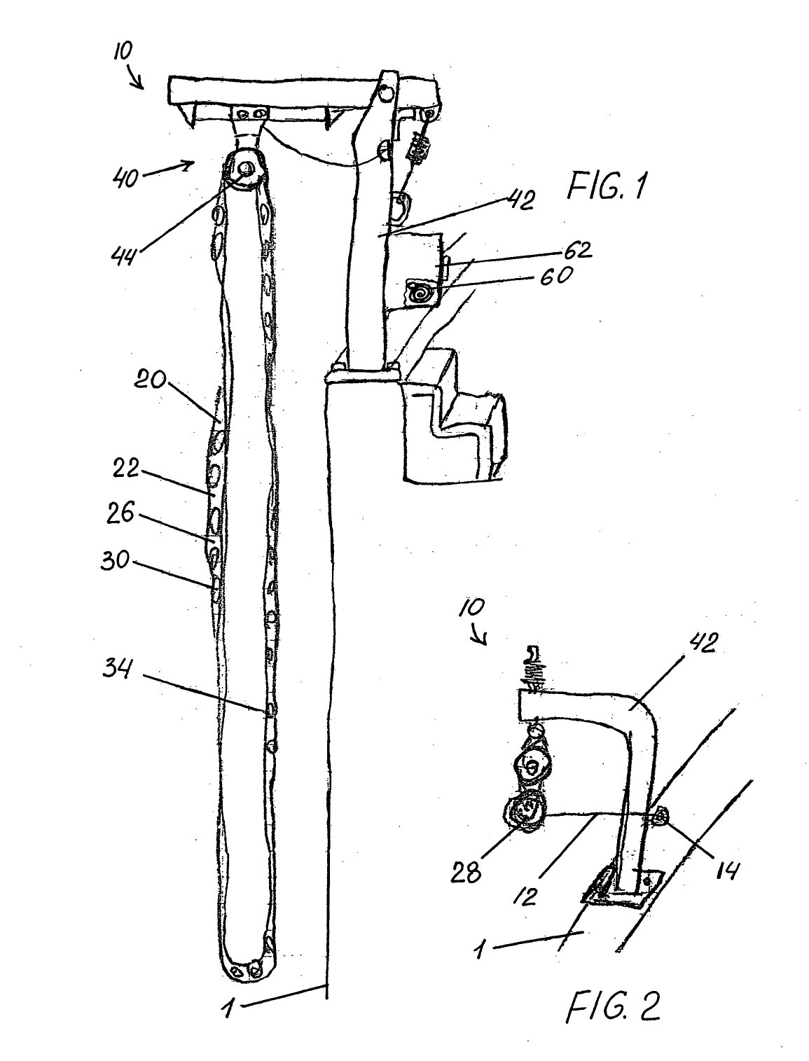

As seen on FIGS. 2 and 4 belting ladder 20 forms a coil 28 for storing. Escape system 10 may further include a tug-tab 12 for releasing belting ladder 20 from a coiled orientation seen on FIG. 2 into an extended suspended orientation illustrated on FIG. 1. In some cases, fire-escape belting ladder 20 may further include an alarm-actuated device 14 for releasing belting ladder 20.

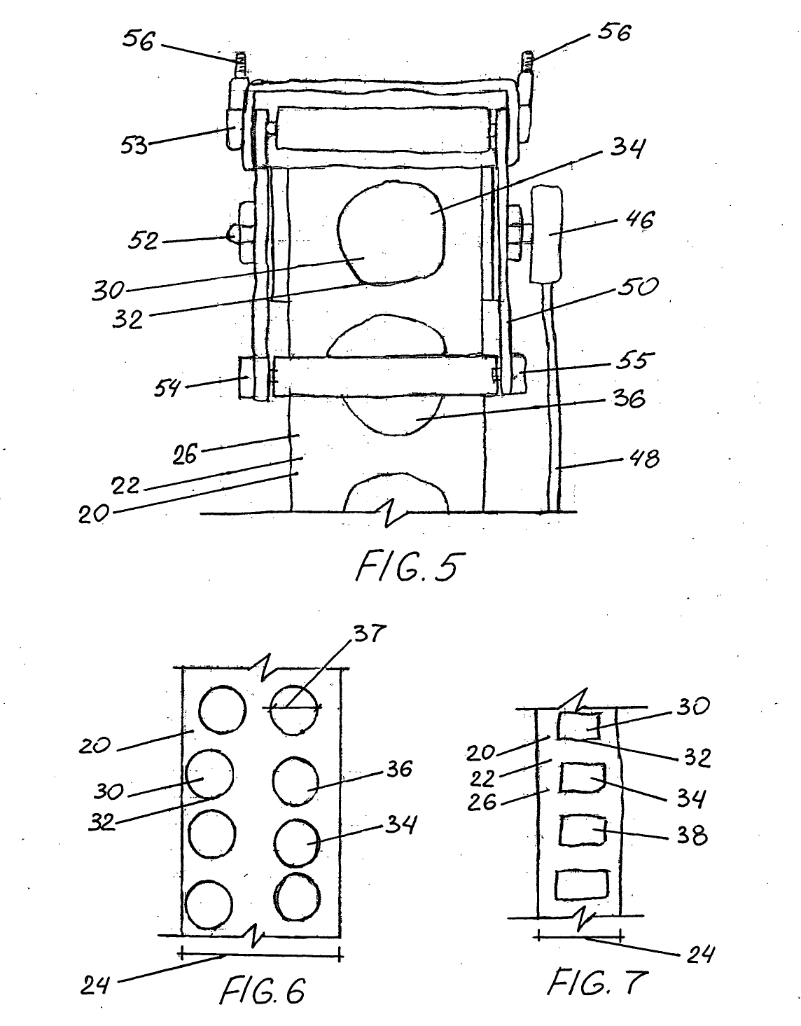

FIGS. 5 and 6 show apertures 30 having substantially round shapes 36 with preferred diameter 37 of approximately six inches.

FIG. 7 shows one of the preferred embodiments having transverse edge portions 32 being substantially straight horizontal with belting ladder 20 being vertically oriented. Apertures 30 on FIG. 7 have substantially rectangular shapes 38 which are approximately six inches wide and approximately six inches high.

Width 24 of band 22 may be approximately ten inches, as shown on FIGS. 1, 5 and 7. Alternatively, if conditions require a bigger ladder to accommodate a larger number of people using the ladder simultaneously, width 24 of belting ladder 20 can be approximately twenty inches or wider and have therefore more longitudinally-spaced apertures 30. An example of such alternative ladder 20 is shown on FIG. 6.

While the principles of the invention have been shown and described in connection with specific embodiments, it is to be understood that such embodiments are by way of example and are not limiting.

1. An escape system for a building comprising:
an endless belting ladder formed by an endless elongated band of a flat flexible reinforced belting material having a plurality of longitudinally-spaced apertures each with a substantially transverse edge portion thereby forming rung-like features along the belting material to receive a person's foot or hand; and
a pulley system characterized by a support structure mountable to the building, at least one substantially cylindrical member rotatably secured with respect to the support structure, and a speed reducer controlling the rotation of the cylindrical member,
whereby the endless band is secured around the cylindrical member.

2. The escape system of claim 1 wherein the speed reducer is a gear box set for a maximum speed of the descending movement of the belting ladder.

3. The escape system of claim 1 wherein the pulley system further includes at least one braking cord for slowing or stopping the descend of the endless belting ladder by pulling the cord.

4. The escape system of claim 1 wherein the support structure includes a frame having a central bar, an overhead shaft, and a first and a second lower rods.

5. The escape system of claim 4 wherein the at least one cylindrical member is a head pulley rotatably secured with respect to the central bar.

6. The escape system of claim 4 includes an adjustable spring-tension-roller mounted on the overhead shaft.

7. The escape system of claim 4 includes a first and a second adjustable belt-snubbers respectively positioned on the first and the second lower rods.

8. The escape system of claim 1 includes a set of safety belts with hooks for securing persons to the ladder.

9. The escape system of claim 8 further includes a fireproof box affixed to the support structure, whereby the safety belts are stored within the box.

10. The escape system of claim 1 wherein the endless belting ladder forms a coil for storing.

11. The escape system of claim 10 further includes a tug-tab for releasing the belting ladder from a coiled orientation into an extended suspended orientation.

12. The escape system of claim 10 further including an alarm-actuated device for releasing the belting ladder.

13. The escape system of claim 1 wherein the belting material is conveyor belting.

14. The escape system of claim 1 wherein the apertures have substantially round shapes.

15. The escape system of claim 1 wherein the transverse edge portions are substantially straight horizontal edges when the belting ladder is vertically oriented.

16. The escape system of claim 15 wherein the apertures have substantially rectangular shapes.
